(19) United States
(12) Patent Application Publication
(10) Pub. No.: US 2012/0186261 A1
(43) Pub. Date: Jul. 26, 2012

(54) SYSTEM AND METHOD FOR A GAS TURBINE EXHAUST DIFFUSER

(75) Inventors: Amit Surendra Toprani, Greenville, SC (US); Samuel David Draper, Simpsonville, SC (US)

(73) Assignee: GENERAL ELECTRIC COMPANY, Schenectady, NY (US)

(21) Appl. No.: 13/010,272

(22) Filed: Jan. 20, 2011

(51) Int. Cl. F02C 7/00

(52) U.S. Cl. 60/772; 60/39.5

(57) ABSTRACT

In one aspect, an exhaust diffuser for a gas turbine is disclosed. The exhaust diffuser may generally include an inner casing and an outer casing spaced radially apart from the inner casing so as to define a passage for receiving exhaust gases of the gas turbine. Additionally, the exhaust diffuser may include a fluid outlet configured to inject a fluid into the exhaust gases flowing through the passage.

### FIELD OF THE INVENTION

The present subject matter relates generally to gas turbines and, more particularly, to a system and method for injecting fluid into the exhaust gases flowing through a gas turbine exhaust diffuser in order to provide an increased turndown capability to the gas turbine.

### BACKGROUND OF THE INVENTION

Combined cycle power generation systems typically include a gas turbine coupled to a heat recovery steam generation (HRSG) system. The gas turbine generally includes a compressor section, a combustion section and a turbine section. The compressor section is typically characterized by an axial compressor having multiple stages of rotating blades and stationary vanes. Ambient air enters the compressor and the rotating blades and stationary vanes progressively impart kinetic energy to the air in order to bring it to a highly pressurized state. The pressurized air exits the compressor and flows to the combustion section where it is mixed with fuel and burned within one or more combustors to generate combustion gases. The combustion gases exiting the combustors flow to the turbine section where they expand to produce work. The heated exhaust gases discharged from the turbine section then flow through the gas turbine's exhaust diffuser and may then be delivered to the HRSG system as a source of heat energy. In particular, the heat from the exhaust gases may be transferred to a water source in order to generate high-pressure, high-temperature steam. In turn, the steam may be used within one or more steam turbines to produce energy.

As is generally understood, the minimum load or turndown capability of a gas turbine is an important consideration in operating a gas turbine. Specifically, turndown capability corresponds to the ability of a gas turbine operator to reduce the load on the gas turbine, which is generally accomplished by reducing the amount of fuel supplied to the combustors. Accordingly, as the turndown capability of a gas turbine is increased, the amount of fuel needed to operate the machine during off-peak periods (e.g., at night) is reduced, thereby resulting in significant fuel cost savings. However, as a gas turbine is turned down, the temperature of the exhaust gases discharged from the turbine steadily increase. Unfortunately, such increased exhaust temperatures can be problematic for downstream components, such as the HRSG system of a combined power cycle generation system. For example, it is often the case that the HRSG system is designed to operate at a maximum temperature that is below the exhaust temperatures that may be reached by the gas turbine at relatively low turndown values (e.g., less than 50% load). In such cases, the turndown capability of the gas turbine is limited by the maximum operating temperature of the HRSG system.

Current attempts to increase turndown capabilities have focused on adjusting the operation of the combustors of the gas turbine. However, determining how and to what extent to adjust the combustor operation is often a difficult task. Moreover, adjustments to the operation of the combustors may often lead to reduced combustion efficiency and other undesirable results, such as increased emissions, increased combustion dynamics and like.

Accordingly, it is desirable to be able to simply and efficiently increase turndown without supplying exhaust gases to downstream components, such as an HRSG system, at temperatures that exceed the maximum operating temperatures of such components.

### BRIEF DESCRIPTION OF THE INVENTION

Aspects and advantages of the invention will be set forth in part in the following description, or may be obvious from the description, or may be learned through practice of the invention.

In one aspect, the present subject matter discloses an exhaust diffuser for a gas turbine. The exhaust diffuser may generally include an inner casing and an outer casing spaced radially apart from the inner casing so as to define a passage for receiving exhaust gases of the gas turbine. Additionally, the exhaust diffuser may include a fluid outlet configured to inject a fluid into the exhaust gases flowing through the passage.

In another aspect, the present subject matter discloses an exhaust diffuser for a gas turbine. The exhaust diffuser may generally include an inner casing and an outer casing spaced radially apart from the inner casing so as to define a passage for receiving exhaust gases of the gas turbine. Additionally, the exhaust diffuser may include a plurality of struts extending between the inner casing and the outer casing. Further, a fluid outlet may be defined in at least one the struts and may be configured to inject a fluid into the exhaust gases flowing through the passage.

In a further aspect, the present subject matter disclosed a method for cooling exhaust gases flowing through an exhaust diffuser of a gas turbine. The method may generally include supplying fluid to a fluid outlet of the exhaust diffuser and injecting the fluid through the fluid outlet and into the exhaust gases flowing through the exhaust diffuser.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, schematic diagram of one embodiment of a system in accordance with aspects of the present subject matter;

FIG. 2 illustrates a cross-sectional side view of one embodiment of an exhaust diffuser suitable for use with the disclosed system in accordance with aspects of the present subject matter;

FIG. 3 illustrates a cross-sectional view of the exhaust diffuser shown in FIG. 2 taken along line 3-3;

FIG. 4 illustrates a cross-sectional view of the exhaust diffuser shown in FIG. 2 taken along line 4-4;

FIG. 5 illustrates a cross-sectional side view of another embodiment of an exhaust diffuser suitable for use with the disclosed system in accordance with aspects of the present subject matter;

FIG. 6 illustrates a cross-sectional view of the exhaust diffuser shown in FIG. 5 taken along line 6-6;

FIG. 7 illustrates a cross-sectional side view of a further embodiment of an exhaust diffuser suitable for use with the disclosed system in accordance with aspects of the present subject matter; and

FIG. 8 illustrates a cross-sectional view of the exhaust diffuser shown in FIG. 7 taken along line 8-8.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and method for reducing the temperature of the exhaust gases exiting the gas turbine and flowing to downstream components, such as the heat recovery steam generation (HRSG) system of a combined cycle power generation system. In particular, the present subject matter is directed to an exhaust diffuser having one or more fluid outlets for injecting a cooling fluid into the exhaust gases exiting the turbine section of the gas turbine. For example, in several embodiments, fluid outlets may be defined or otherwise located in one or more of the struts of the exhaust diffuser to permit a cooling fluid, such as water, air, fuel, and/or any other suitable liquid and/or gas, to be injected directly into the flow of the exhaust gases. Accordingly, the temperature of the exhaust gases exiting the gas turbine may be significantly reduced prior to such gases being delivered to any downstream components.

It should be appreciated that, by configuring the exhaust diffuser to include fluid outlets for injecting fluid into the flow of exhaust gases, an increased turndown capability may be achieved without exceeding the maximum temperature ratings of an HRSG system or any other downstream component. In particular, the heightened temperatures reached at relatively low turndown values (e.g., less than 50% load) may be controlled by injecting fluid into the exhaust gases flowing within the exhaust diffuser, thereby reducing the exhaust temperature of the gas turbine to an acceptable operating temperature for any downstream components. As such, the turndown capability of the gas turbine need not be limited by the maximum operating temperature of such downstream components.

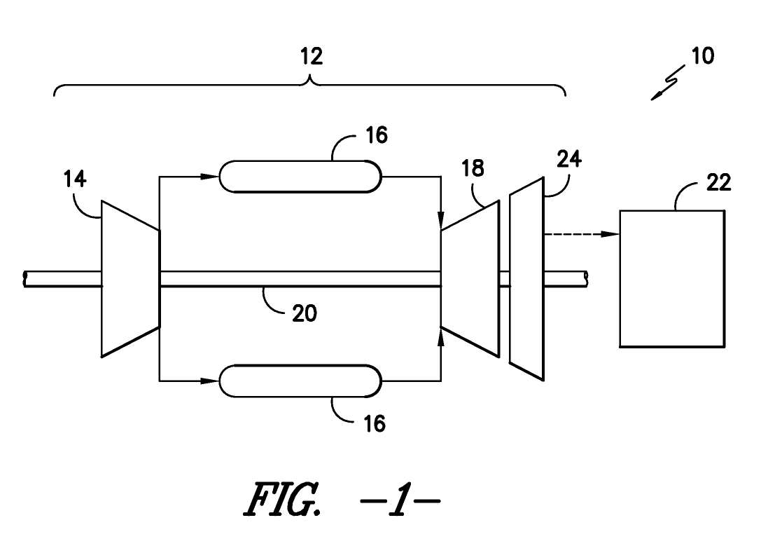

Referring now to the drawings, FIG. 1 illustrates a simplified, schematic diagram of one embodiment of a combined cycle power generation system 10 in accordance with aspects of the present subject matter. As shown, the system 10 includes a gas turbine 12 having a compressor section 14, a combustion section 16 and a turbine section 18. The combustion section 16 may generally be characterized by a plurality of combustors (not shown) disposed around an annular array about the axis of the gas turbine 12. The compressor section 14 and the turbine section 18 may be coupled by a rotor shaft 20. The rotor shaft 20 may be a single shaft or a plurality of shaft segments coupled together to form the rotor shaft 20. During operation of the gas turbine 12, the compressor section 14 supplies compressed air to the combustion section 16. The compressed air is mixed with fuel and burned within each combustor and hot gases of combustion flow from the combustion section 16 to the turbine section 18, wherein energy is extracted from the hot gases to generate power.

Additionally, the system 10 may include an HRSG system 22 disposed downstream of the gas turbine 12. As is generally understood, the HRSG system 22 may be configured to receive the heated exhaust gases exiting the turbine section 18 of the gas turbine 12. For example, in several embodiments, the exhaust gases may be supplied to the HRSG system 22 through an exhaust diffuser 24 of the gas turbine 12. The exhaust gases supplied to the HRSG system 22 may, in turn, be used as a heat source for generating high-pressure, high-temperature steam. The steam may then be passed through a steam turbine (not shown) in order to generate power. In addition, the steam may also be passed to other processes within the system 10 in which superheated steam may be utilized.

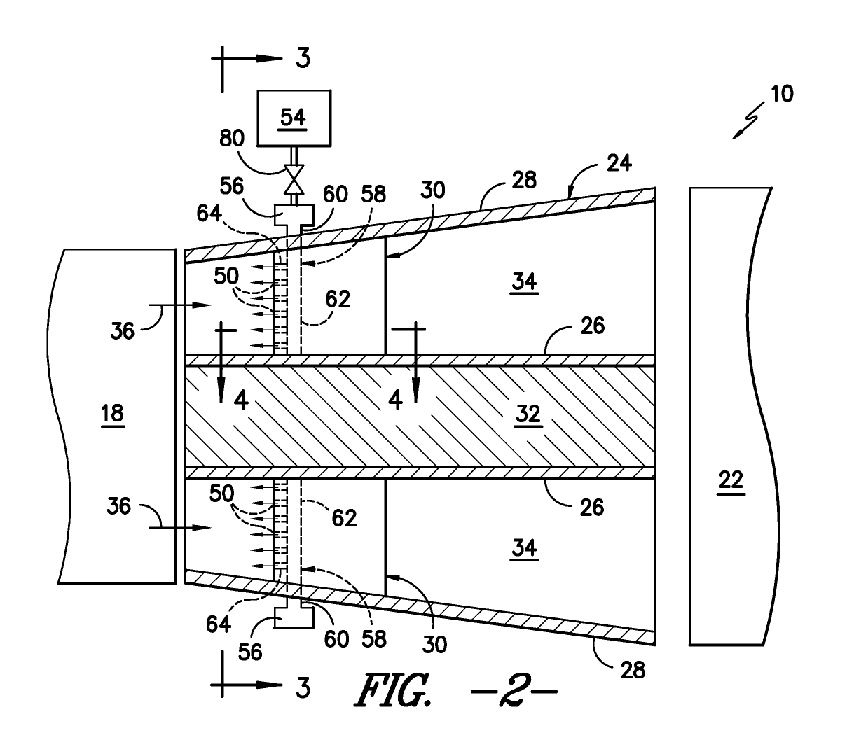

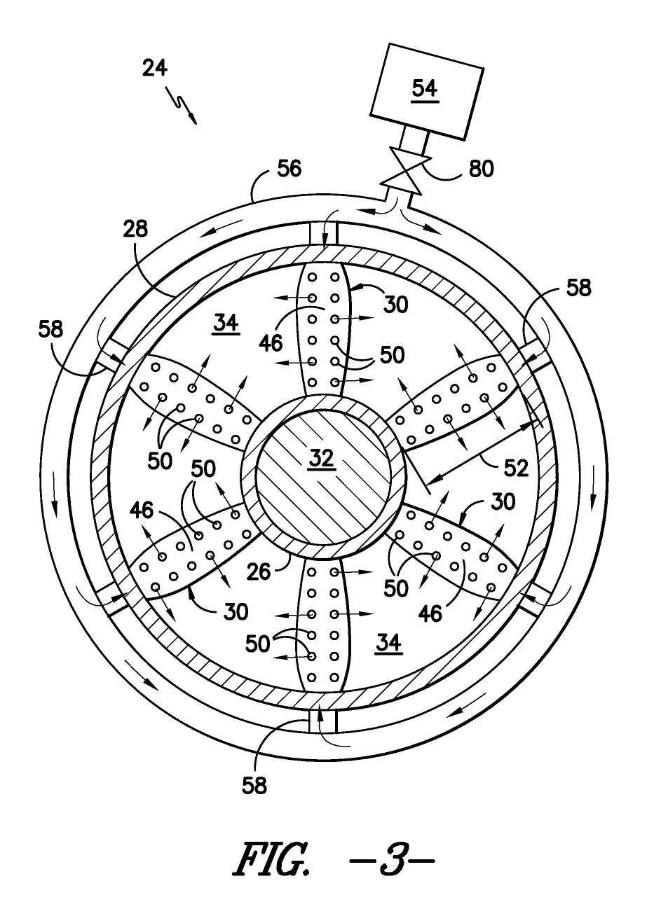

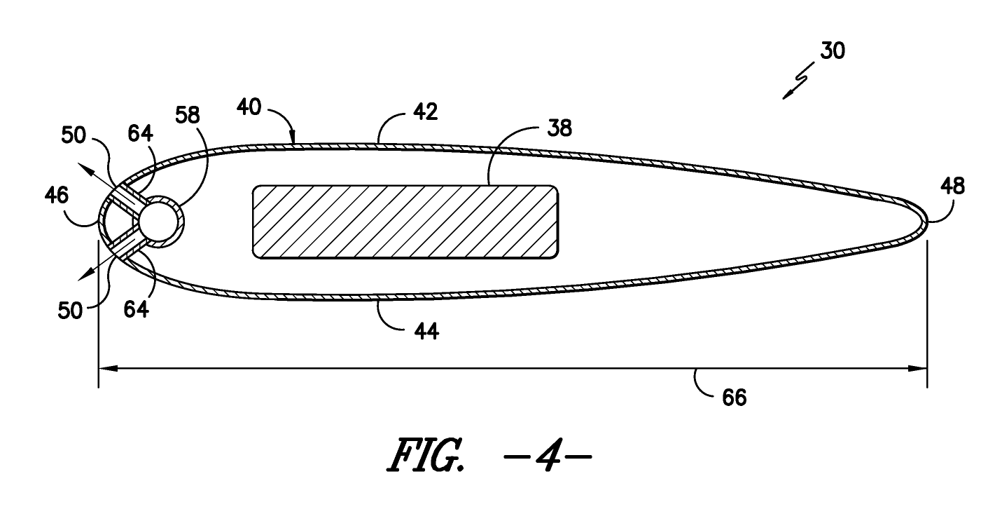

Referring now to FIGS. 2-4, there are illustrated simplified views of one embodiment of an exhaust diffuser 24 suitable for use with the disclosed system 10 in accordance with in aspects of the present subject matter. In particular, FIG. 2 illustrates a cross-sectional side view of one embodiment of the exhaust diffuser 24. FIG. 3 illustrates a cross-sectional view of the exhaust diffuser 24 shown in FIG. 2 taken along line 3-3. Additionally, FIG. 4 illustrates a cross-sectional view of the exhaust diffuser 24 shown in FIG. 2 taken along line 4-4.

As shown, the exhaust diffuser 24 generally includes an inner casing 26, an outer casing 28 and one or more struts 30. The inner casing may generally comprise an arcuate casing configured to surround one or more of the rotating components 32 of the gas turbine 12 (FIG. 1). For example, the inner casing 26 may surround or encase the rotor shaft 20 (FIG. 1), bearing(s) (not shown), and/or other rotating components 32 of the gas turbine 12. The outer casing 28 may generally be spaced apart radially from the inner casing 26 and may generally surround the inner casing 26 so as to define an exhaust passage 34 for receiving the exhaust gases 36 exiting the turbine section 18 of the gas turbine 12. In general, the exhaust diffuser 24 may be configured to convert the kinetic energy of the exhaust gases 36 into potential energy in the form of increased static pressure. Thus, as shown, the outer casing 28 may generally be angled relative to the inner casing 26 such that the exhaust passage 34 comprises a duct or passage of increasing area in the downstream direction (e.g., in the direction of the HRSG system 22). As such, the exhaust gases 36 may spread or diffuse over the length of the exhaust diffuser 24, thereby reducing the velocity of the exhaust gases 36 and increasing their static pressure. It should be appreciated that, although the outer casing 28 is shown as a single walled construction, the outer casing 28 may also be configured as a double or multiple walled construction having separate, spaced apart walls.

The struts 30 of the exhaust diffuser 24 may generally be configured to extend between the inner casing 26 and the outer casing 28 so as to orient the outer casing 28 with respect to the inner casing 26 and to also serve as structural components for the exhaust diffuser 24. In the context of the present disclosure, the term “strut” includes any structure or supporting member that extends between the inner and outer casings 26, 28. As particularly shown in FIG. 4, each strut 30 may include an inner strut portion 38 and a strut airfoil 40. The inner strut portion 38 may generally be configured to serve as the primary structural or load-bearing component of the strut 30. The strut airfoil 40 may generally be configured to surround the inner strut portion 38. Additionally, in several embodiments, the strut airfoil 40 may define an aerodynamic shape or profile in order to provide aerodynamic characteristics to the exhaust diffuser 24 and thereby improve and/or control the flow of exhaust gases 36 through the diffuser 24. For example, the strut airfoil 40 may include a first cambered surface 42 and a second cambered surface 44 configured to be joined together to define an aerodynamic profile. Thus, each strut 30 may define a leading edge 46 at the upstream ends of the cambered surfaces 42, 44 and a trailing edge 48 at the downstream ends of the cambered surfaces 42, 44. As shown in the illustrated embodiment, the leading edge 46 of each strut 30 may generally face in the opposite direction of the flow of the exhaust gases 36 exiting the turbine section 18 of the gas turbine 12.

It should be appreciated that the present subject matter is generally applicable to any exhaust diffuser known in the art and, thus, need not be limited to any particular type of exhaust diffuser configuration. For example, as shown in the illustrated embodiment, the exhaust diffuser 24 comprises an axial exhaust diffuser, whereby the exhaust gases 36 from the turbine section 18 may be directed toward the HRSG system 22 axially (i.e., in a direct non-radial path). However, in other embodiments, the exhaust diffuser 24 may comprise a radial exhaust diffuser, whereby the exhaust gases 36 may be re-directed by exit guide vanes (not shown) to exit the exhaust diffuser 24 through a 90-degree turn (or any other angled turn) outwardly or radially towards the HRSG system 22.

Referring still to FIGS. 2-4, the exhaust diffuser 24 may also include one or more fluid outlets 50 for injecting fluid, such as water, air, fuel and/or the like, into the flow of exhaust gases 36 received within the exhaust passage 34. As indicated above, by injecting fluid into the exhaust gases 36 using the disclosed fluid outlets 50, the exhaust temperature of the gas turbine 12 may be reduced to an acceptable operating temperature for downstream components, such as the illustrated HRSG system 22. Accordingly, given that the maximum temperature of the exhaust gases 36 exiting the turbine section 18 need not be limited to the maximum operating temperature of such downstream components, the turndown capability of the gas turbine 12 may be significantly increased. In the context of the present disclosure, the term “fluid outlet” or “fluid outlets” may include any opening(s), orifice(s), nozzle(s), fluid injector(s), sprayer(s), mister(s), fogger(s) and/or any other suitable structure(s) and/or component(s) configured to direct, spray, mist, fog, expel and/or otherwise inject a suitable fluid or mixture of fluids into the exhaust gases 36 flowing through the exhaust passage 34 of the exhaust diffuser 24. For example, the fluid outlets 50 may comprise openings defined in one or more of the components of the exhaust diffuser 24 into which a spray nozzle, fluid injector and/or other suitable device is mounted for spraying or otherwise injecting fluid into the flow of exhaust gases 36.

In general, the fluid outlets 50 may be defined or otherwise formed in any suitable component of the exhaust diffuser 24 and at any suitable location within the diffuser 24 that enables fluid to be injected into the flow of exhaust gases 36. Thus, in several embodiments of the present subject matter, one or more fluid outlets 50 may be defined in a portion of each strut 30, such as by being defined in the strut airfoil 40 of each strut 30. For example, in the illustrated embodiment, the fluid outlets 50 may be defined at and/or adjacent to the leading edge 46 of the strut airfoil 40 such that fluid may be injected substantially forward into the flow path of the exhaust gases 36. Specifically, as shown in FIG. 3, the fluid outlets 50 may be defined at and/or adjacent to the leading edge 46 and may be spaced apart along the height 52 of the strut 30. As such, the fluid flowing through the fluid outlets 50 may be injected into the exhaust gases 36 at various radial locations within the exhaust passage 34 along such height 52.

Additionally, in a particular embodiment of the present subject matter, the fluid outlets 50 may be defined in the struts 30 down each side of the leading edge 46 such that fluid may be injected into the exhaust gases 36 flowing past the leading edge 46 and along the first and second cambered surfaces 42, 44. For example, as shown in FIGS. 3 and 4, the fluid outlets 50 may be defined in pairs along the leading edge 46, with each fluid outlet 50 being configured to expel fluid forward into the exhaust gases 36 directed to each side of the leading edge 46. Such a configuration may allow the fluid to be injected into the exhaust gases 36 without disrupting the aerodynamic flow of the gases 36 over the strut airfoil 40. However, in alternative embodiments, the fluid outlets 50 need not be formed in pairs along each side of the leading edge 46 but may generally be defined in the strut 30 to have any suitable configuration and/or pattern. For instance, each strut 30 may include a single column of fluid outlets 50 defined at and/or adjacent to the leading edge 46.

Moreover, it should be appreciated that the fluid outlets 50 need not be defined at and/or adjacent to the leading edge 46 of the strut airfoil 40 but may generally be defined at any suitable location around the outer perimeter of the strut 30. For example, the fluid outlets 50 may be defined in the strut 30 at locations further downstream on the strut airfoil 40, such as by being defined in a middle portion of the first and/or second cambered surfaces 42, 44 or by being defined at and/or adjacent to the trailing edge 48 of the strut airfoil 40. It should also be appreciated the struts 30 may define any suitable number of fluid outlets 50. For instance, in the illustrated embodiment, each strut 30 defines a plurality of fluid outlets 50. However, in other embodiments, each strut 30 may only define a single fluid outlet 50. In further embodiments, fluid outlets 50 may only be defined in a portion of the struts 30 disposed within the exhaust diffuser 24.

Referring still to FIGS. 2-4, the fluid outlets 50 may generally be in flow communication with a fluid source 54 (e.g., a water source, air source, fuel source and/or the like) for supplying fluid to each fluid outlet 50. For example, in the illustrated embodiment, the fluid outlets 50 may be coupled to a fluid source 54 through a manifold 56 and a plurality of fluid conduits 58 (e.g., pipes, tubes and/or the like) extending from the manifold 56. Specifically, as shown, the manifold 56 may generally comprise a ring-shaped member surrounding the outer casing 28 of the exhaust diffuser 24 and may be configured to receive fluid from the fluid source 54. As such, the manifold 56 may provide a means for supplying fluid around the outer perimeter of the exhaust diffuser 24. Additionally, the fluid conduits 58 extending from the manifold 56 may generally be configured to transfer the fluid flowing through the manifold 56 to the fluid outlets 50. Thus, in the illustrated embodiment, the fluid conduits 58 may be configured to extend through the outer casing 28 of the exhaust diffuser 24 such that a first end 60 of each fluid conduit 58 is in flow communication with the manifold 56 and a second end 62 of each fluid conduit 58 is disposed within the interior of each strut 30. The fluid received by the conduits 58 may then be supplied to each fluid outlet 50 for direct injection into the stream of exhaust gases 36 flowing through the exhaust passage 34. For example, as particularly shown in FIGS. 2 and 4, the fluid conduits 58 may include connector passages 64 for directing the fluid flowing through the conduits 58 to each fluid outlet 50.

It should be appreciated that, in alternative embodiments, the fluid outlets 50 need not be in flow communication with the fluid source 54 using the exact configuration shown in FIGS. 2-4. Rather, the fluid outlets 50 may generally be coupled to the fluid source 54 using any suitable piping/tubing configuration and/or any other suitable means and/or method known in the art.

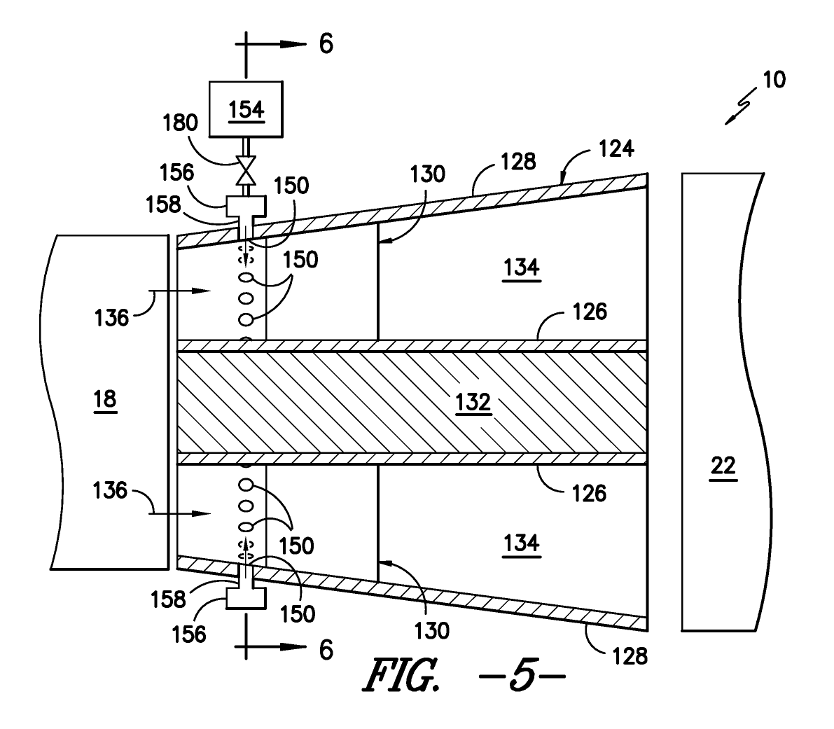

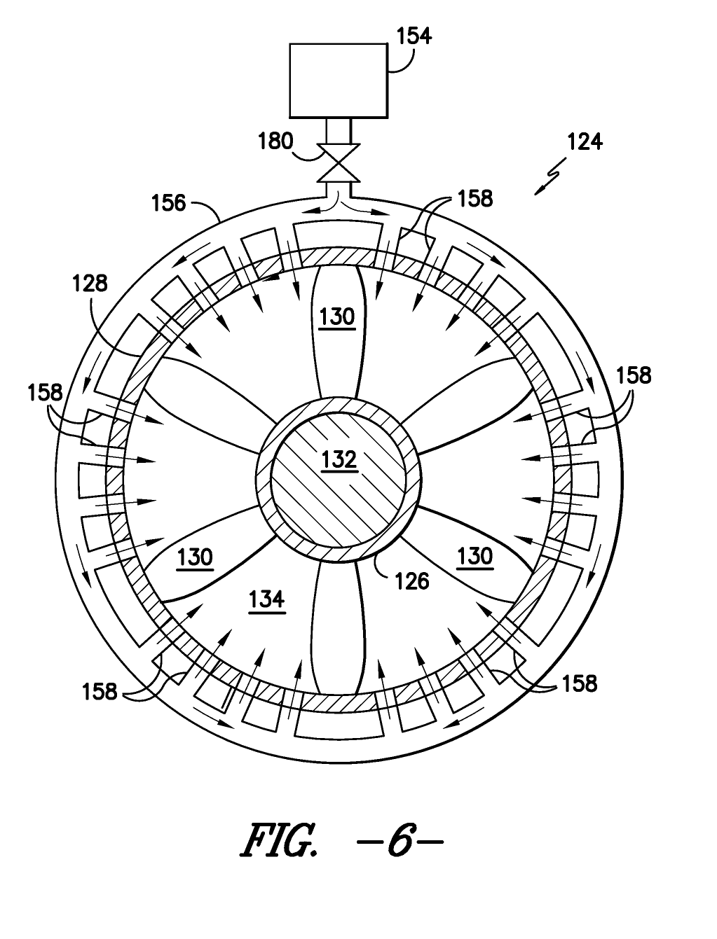

Referring now to FIGS. 5 and 6, there are illustrated simplified views of another embodiment of an exhaust diffuser 124 for use in the disclosed system 10 in accordance with in aspects of the present subject matter. In particular, FIG. 5 illustrates a cross-sectional side view of one embodiment of the exhaust diffuser 124. FIG. 6 illustrates a cross-sectional view of the exhaust diffuser 124 shown in FIG. 5 taken along line 6-6.

In general, the exhaust diffuser 124 may be configured similarly to the exhaust diffuser 24 described above with reference to FIGS. 2-4 and may include many and/or all of the same components. For example, as shown, the exhaust diffuser 124 may include an inner casing 126 configured to encase the rotating components 132 of the gas turbine 12 and an outer casing 128 surrounding the inner casing 126. The outer casing 128 may generally be spaced apart radially from the inner casing 126 such that a diverging exhaust passage 134 is defined for receiving the exhaust gases 136 exiting the turbine section 18 of the gas turbine 12. Additionally, the exhaust diffuser 124 may include one or more struts 130 extending between the inner casing 126 and the outer casing 128. The exhaust diffuser 124 may also include one or more fluid outlets 150 for injecting a suitable fluid or mixture of fluids into the flow of exhaust gases 136. As such, the temperature of the exhaust gases 136 may be reduced significantly prior to such gases 136 being delivered to any downstream components, such as the HRSG system 22 of the disclosed system 10.

However, unlike the embodiment described above with reference to FIGS. 2-4, the fluid outlets 150 may generally be defined in and/or through the outer casing 128 of the exhaust diffuser 124 to allow fluid to be injected into the exhaust gases 136 around the outer perimeter of the diffuser 124. In such an embodiment, the fluid outlets 150 may generally be in flow communication with a fluid source 154 using any suitable means and/or method. For example, as shown in FIGS. 5 and 6, a manifold 156 may extend around the outer perimeter of the outer casing 128 and may be configured to receive fluid from the fluid source 154. Additionally, a plurality of fluid conduits 158 may extend from the manifold 156 and into the outer casing 128 in order to direct the fluid flowing through the manifold 156 to each fluid outlet 150.

It should be appreciated that the fluid outlets 150 may generally be defined at any suitable location along the outer casing 128. For example, in the illustrated embodiment, the fluid outlets 150 are defined in the outer casing 128 upstream of the struts 130. In alternative embodiments, the fluid outlets 150 may be defined in the outer casing 128 at more downstream locations, such as by being aligned with a portion of the width 66 (FIG. 4) of the struts 130 or by being located downstream of the struts 130. Moreover, as particularly shown in FIG. 6, in several embodiments, the fluid outlets 150 may generally be defined around the entire circumference of the outer casing 128. However, in other embodiments, the fluid outlets 150 may be defined along only a portion of the outer casing's circumference.

It should also be appreciated that fluid outlets 150 described with reference to FIGS. 5 and 6 may be combined with the fluid outlets 50 described with reference to FIGS. 2-4. For example, in several embodiments of the present subject matter, fluid outlets 50, 150 may be defined in both the outer casing 28, 128 and the struts 30, 130, with the fluid outlets 50, 150 being supplied fluid through a common manifold 56, 156 or through separate manifolds 56, 156. Moreover, in addition to fluid outlets 50, 150 being defined in the outer casing 28, 128 and/or the struts 30, 130 or as an alternative thereto, fluid outlets may also be defined in the inner casing 26, 126 of the exhaust diffuser 24, 124 to permit fluid to be injected into the flow of exhaust gases 36, 136.

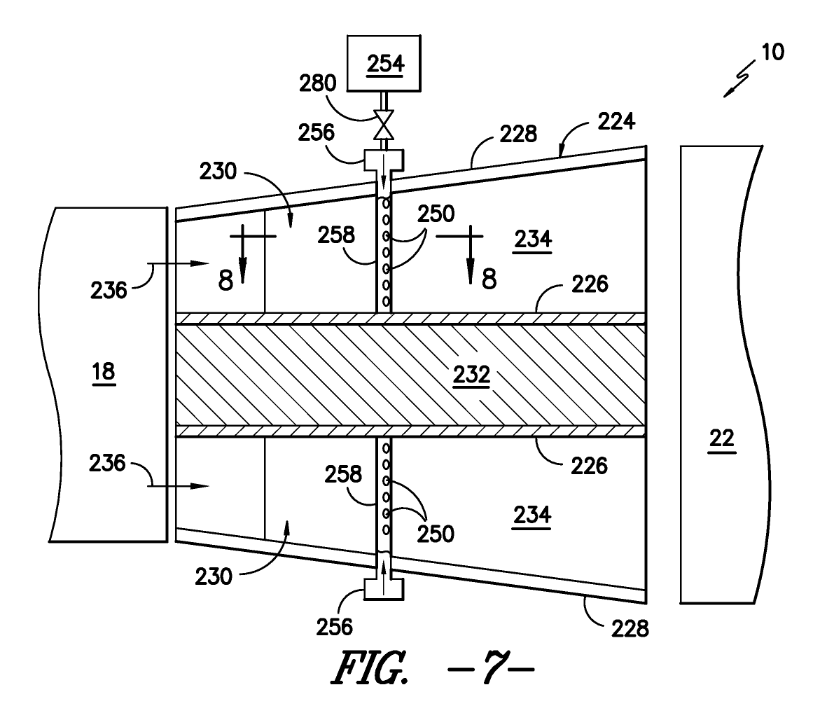

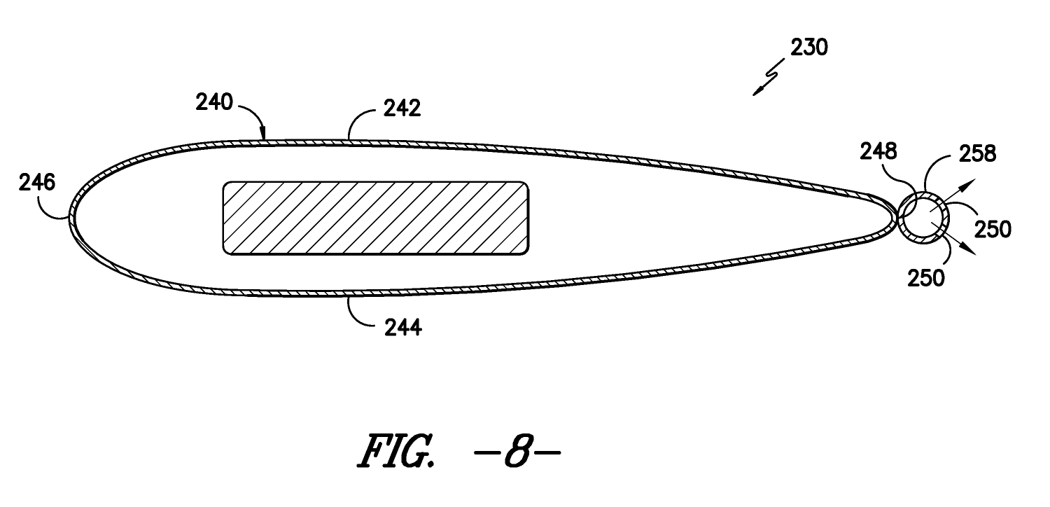

Referring now to FIGS. 7 and 8, there are illustrated simplified views of another embodiment of an exhaust diffuser 224 for use in the disclosed system 10 in accordance with in aspects of the present subject matter. In particular, FIG. 7 illustrates a cross-sectional side view of one embodiment of the exhaust diffuser 224. FIG. 8 illustrates a cross-sectional view of the exhaust diffuser 224 shown in FIG. 7 taken along line 8-8.

In general, the exhaust diffuser 224 may be configured similarly to the exhaust diffusers 24, 124 described above with reference to FIGS. 2-6 and may include many and/or all of the same components. For example, as shown, the exhaust diffuser 224 may include an inner casing 226 configured to encase the rotating components 232 of the gas turbine 12 and an outer casing 228 surrounding the inner casing 226. The outer casing 228 may generally be spaced apart radially from the inner casing 226 such that a diverging exhaust passage 234 is defined for receiving the exhaust gases 236 exiting the turbine section 18 of the gas turbine 12. Additionally, the exhaust diffuser 224 may include one or more struts 230 extending between the inner casing 226 and the outer casing 228. The exhaust diffuser 224 may also include one or more fluid outlets 250 for injecting a suitable fluid or mixture of fluids into the flow of exhaust gases 236. As such, the temperature of the exhaust gases 236 may be reduced significantly prior to such gases 236 being delivered to any downstream components, such as the HRSG system 22 of the disclosed system 10.

However, unlike the embodiment described above with reference to FIGS. 2-4, the fluid outlets 250 may be defined in one or more fluid conduits 258, such as pipes, tubes and the like, extending through the outer casing 228 to a location(s) within the exhaust passage 234 exterior of the struts 230. For example, in several embodiments, one or more fluid conduits 258 may extend through the outer casing 228 and may be attached and/or positioned adjacent to the outer perimeter of the strut airfoil 240 of each strut 250. Thus, in the illustrated embodiment, fluid conduits 258 (one of which is shown) may be attached and/or positioned adjacent to the trailing edge 248 of each strut airfoil 240. As such, the fluid flowing through the fluid conduits 258 may be expelled from the fluid outlets 250 and injected into the flow of exhaust gases 236 as such gases 236 flow past each strut 230. In other embodiments, it should be appreciated that the disclosed fluid conduits 258 may be disposed at any other suitable location within the exhaust passage 234. For instance, the fluid conduits 258 may be attached and/or positioned adjacent to the strut airfoil 240 at any other suitable location, such as by being attached and/or positioned adjacent to one of the cambered surfaces 242, 244 and/or the leading edge 246 of the strut airfoil 240. Alternatively, the fluid conduits 258 may be disposed at various other locations, such as at locations between each of the struts 230 and/or at any other suitable locations within the exhaust passage 234.

It should be appreciated that the fluid outlets 250 defined in the fluid conduits 258 may generally be in flow communication with a fluid source 254 using any suitable means and/or method. For example, as shown in FIG. 7, a manifold 256 may extend around the outer perimeter of the outer casing 228 and may be configured to receive fluid from the fluid source 254. Additionally, the fluid conduits 258 may generally be coupled to the manifold 256 to permit the fluid flowing through the manifold 256 to be supplied to each fluid outlet 250. It should also be appreciated that the fluid outlets 258 described above with reference to FIGS. 7 and 8 may be utilized in addition to having fluid outlets 50, 150, 250 defined in the struts 30, 130, 230, the outer casing 28, 128, 228 and/or the inner casing 26, 126, 226 of the exhaust diffuser 24, 124, 224 or as an alternative thereto.

Additionally, the system 10 disclosed herein may be configured such that the fluid supplied from the fluid source 54, 154, 254 may be selectively injected into the exhaust gases 36, 136, 236 flowing through the exhaust diffuser 24, 124, 224 based upon the exhaust temperature of the gases 36, 136, 236 exiting the turbine section 18 of the gas turbine 12. For example, in several embodiments, it may only be desirable to inject fluid into the exhaust gases 36, 136, 236 when the temperature of such gases 36, 136, 236 exceeds the maximum operating temperature of downstream components, such as the illustrated HRSG system 22 (e.g., when the gas turbine 12 is operating at low turndown values). Thus, the system 10 may also include any suitable means for determining the temperature of the exhaust gases 36, 136, 246 exiting the turbine section 18, such as by including a temperature sensor (not shown) configured to directly measure the temperature of the exhaust gases 36, 136, 236 or by including a suitable processing unit (not shown), such as a computer or turbine controller, configured to estimate and/or calculate the temperature based on one or more operating parameters and/or conditions of the gas turbine 12.

Further, the disclosed system 10 may also include any suitable means known in the art for controlling the amount of fluid supplied to the fluid outlets 50, 150, 250. For instance, as shown in FIGS. 2, 5 and 7, a shut-off or control valve 80, 180, 280 may be positioned between the fluid source 54, 154, 254 and the manifold 56, 156, 256 in order to terminate the supply of fluid to the fluid outlets 50, 150, 250 and/or alter the amount of fluid supplied to the fluid outlets 50, 150, 250. Thus, when the temperature of the exhaust gases 36, 136, 236 is below the maximum operating temperature of the HRSG system 22 and/or any other downstream component, the supply of fluid to the fluid outlets 50, 150, 250 may be shut off in order to maximize the downstream efficiency of the heated exhaust gases 36, 136, 236. However, as the exhaust temperature increase during turndown of the gas turbine 12, the amount of fluid supplied to the fluid outlets 50, 150, 250 may be controlled in order to adequately cool the exhaust gases 36, 136, 236 to an acceptable operating temperature for any downstream components. It should be appreciated that, in alternative embodiments, the valves 80, 180, 280 may be placed at various other locations within the system 10 in order to control the amount of fluid supplied to the fluid outlets 50, 150, 250. For example, one or more valves 80, 180, 280 may be disposed within and/or coupled to each fluid conduit 58, 158, 258. Alternatively, a valve 80, 180, 280 may be associated with each fluid outlet 50, 150, 250, such as by including a valve actuated nozzle within each fluid outlet 50, 150, 250.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An exhaust diffuser for a gas turbine, the exhaust diffuser comprising:
an inner casing;
an outer casing spaced radially apart from said inner casing so as to define a passage for receiving exhaust gases of the gas turbine;
a plurality of struts extending between said inner casing and said outer casing; and
a fluid outlet defined in at least one of said plurality of struts, said fluid outlet being configured to inject a fluid into the exhaust gases flowing through said passage.

2. The exhaust diffuser of claim 1, wherein each of said plurality of struts includes a leading edge, said fluid outlet being defined adjacent to said leading edge.

3. The exhaust diffuser of claim 1, further comprising a manifold extending around said outer casing, said manifold being in flow communication with a fluid source.

4. The exhaust diffuser of claim 3, wherein said fluid outlet is coupled to said manifold through a fluid conduit extending at least partially within said at least one of said plurality of struts.

5. The exhaust diffuser of claim 1, further comprising a plurality of fluid outlets defined in each of said plurality of struts, said plurality of fluid outlets being configured to inject a fluid into the exhaust gases flowing through said passage.

6. The exhaust diffuser of claim 1, further comprising a valve disposed between said fluid outlet and a fluid source, said valve being configured to control the amount of fluid supplied to said fluid outlet from said fluid source.

7. An exhaust diffuser for a gas turbine, the exhaust diffuser comprising:
an inner casing;
an outer casing spaced radially apart from said inner casing so as to define a passage for receiving exhaust gases of the gas turbine; and
a fluid outlet configured to inject a fluid into the exhaust gases flowing through said passage.

8. The exhaust diffuser of claim 7, further comprising a strut extending between said inner casing and said outer casing, said fluid outlet being defined in said strut.

9. The exhaust diffuser of claim 8, wherein said strut includes a leading edge, said fluid outlet being defined in said strut adjacent to said leading edge.

10. The exhaust diffuser of claim 8, further comprising a plurality of fluid outlets defined in said strut, said plurality of fluid outlets being spaced apart along a height of said strut.

11. The exhaust diffuser of claim 7, further comprising a plurality of struts extending between said inner and outer casings, each of said plurality of struts defining a fluid outlet configured to inject a fluid into the exhaust gases flowing through said passage.

12. The exhaust diffuser of claim 7, wherein said fluid outlet is defined in at least one of said outer casing, said inner casing and a fluid conduit extending within said passage.

13. The exhaust diffuser of claim 7, further comprising a manifold extending around said outer casing, said manifold being in flow communication with a fluid source.

14. The exhaust diffuser of claim 13, wherein said fluid outlet is coupled to said manifold through a fluid conduit.

15. The exhaust diffuser of claim 7, further comprising a valve disposed between said fluid outlet and a fluid source, said valve being configured to control the amount of fluid supplied to said fluid outlet from said fluid source.

16. A method for cooling exhaust gases flowing through an exhaust diffuser of a gas turbine, the method comprising:
supplying fluid to a fluid outlet of the exhaust diffuser; and
injecting said fluid through said fluid outlet and into the exhaust gases flowing through the exhaust diffuser.

17. The method of claim 16, further comprising determining a temperature of the exhaust gases flowing through the exhaust diffuser.

18. The method of claim 17, further comprising controlling the amount of fluid injected into the exhaust gases based on said temperature.

19. The method of claim 16, wherein supplying fluid to a fluid outlet of the exhaust diffuser comprises supplying fluid to a fluid outlet defined in a strut of the exhaust diffuser.

20. The method of claim 16, wherein supplying fluid to a fluid outlet of the exhaust diffuser comprises supplying fluid to a fluid outlet defined in at least one of an outer casing of the exhaust diffuser, an inner casing of the exhaust diffuser and a fluid conduit extending within the exhaust diffuser.
